(19) United States
(12) Patent Application Publication
(10) Pub. No.: US 2024/0279406 A1
(43) Pub. Date: Aug. 22, 2024

(54) NEW METHOD

(71) Applicant: PROLIGREEN AB, TÄBY (SE)

(72) Inventors: Martin LAWOKO, SOLNA (SE); Maria KARLSSON, TÄBY (SE)

(21) Appl. No.: 18/568,221

(22) PCT Filed: Jun. 7, 2022
(86) PCT No.: PCT/EP2022/065441

§ 371 Date: Dec. 7, 2023

(30) Foreign Application Priority Data
Jun. 8, 2021 (SE) 2150723-1

(51) Int. Cl. C08H 8/00; C07G 1/00; C08L 97/00; D21C 1/02; D21C 3/20; D21C 11/00

(52) U.S. Cl. CPC C08H 8/00; C07G 1/00; C08L 97/005; D21C 1/02; D21C 3/20; D21C 11/0007

(57) ABSTRACT

The invention relates to a method for extraction of hemicellulose, lignin and carbohydrates from a lignocellulosic biomass, wherein the method comprises: 1) extracting hemicellulose from lignocellulosic biomass, by heating lignocellulosic biomass and subcritical water to 110-170° C., under a pressure of from atmospheric pressure up to 2000 psi, and letting hemicelluloses be extracted from the biomass, leaving a first fiber residue, and 2) extracting lignin and carbohydrates from said first fiber residue, by heating said first fiber residue and said second solvent comprising ethanol and water to 110-170° C., under a pressure of from atmospheric pressure up to 2000 psi, and letting lignin and carbohydrates be extracted from said first fiber residue, leaving a second fiber residue. 2) may be performed in a plurality of static cycles. The invention further relates to a lignin obtained by said method.

### TECHNICAL FIELD

The invention relates to the field of consolidated biorefineries and lignin extraction. More specifically, the invention relates to a method for extraction of hemicellulose, lignin and carbohydrates from a lignocellulosic biomass and to lignin extracted through such a method.

### BACKGROUND

Combating climate change has become a global initiative, and a strong case can be made for lignocellulosic biomass to replace fossil sources as a raw material. Lignin accounts for approximately 15-30% of lignocellulosic biomass and is the most abundant natural source of aromatics. From a sustainability and bioeconomical viewpoint, replacing fossil-based aromatics with sustainable solutions is of high interest where lignin could be used as a precursor for biofuel and materials. However, the fractionation recalcitrance of biomass to obtain biopolymers is an obstacle that still demands improvements. One of the conventional pulping processes is the organosolv process. The working principle of the organosolv process is to use an aqueous organic solvent to extract lignin, where low molecular weight aliphatic alcohols are especially used for the extraction.

One of the most promising organosolv processes is the Alcell process, which is based on the biorefinery concept that pulp, lignin, furfurals, acetic acid, and hemicelluloses could all be of value. Generally, the extraction uses a binary ethanol-water solvent system in the range of 20-80 wt % of alcohol at temperatures of 160-220° C. with no catalyst added. High quality pulp has been generated from the process.

With no catalyst added, the extraction solvent has a pH of around 4, owing to the generation of acetic acid from deacetylation of hemicelluloses. For more efficient lignin extraction, a small amount of mineral acid is commonly added. A mild organosolv extraction of lignin subsequent to hydrothermal pretreatment was recently reported. Even more recently, polyhydroxy alcohols, such as butanediol and ethylene glycol in combination with dimethyl carbonate, have been used in the reactive dissolution of biorefinery lignins.

The structure of organosolv-extracted lignin differs from that obtained by other processes. Under acidic conditions and at high temperatures, carbocations formed in the aliphatic side chains are prone to react with electron-rich aromatic carbons in an electrophilic attack. This reaction contributes to the formation of stable C—C bonds in condensation reactions. A common depolymerization reaction in organosolv processes is acidolysis and the subsequent formation of Hibbert's ketone.

More specifically, occurrence of undesirable condensation reactions resulting from carbocations at alpha carbons has been reported. For these reactions, protection strategies have been proposed. One protection strategy is to use chemical protection, where a protecting group deactivates, reversibly or irreversibly, a reactive functional group. One example of this strategy is the addition of formaldehyde in the pretreatment of the biomass. Here, upon acetalization, lignin condensation and the formation of stable C—C bonds are prevented by blocking reactive positions prone to lignin condensation. The resulting derivative can be reversibly deactivated to achieve deprotection. Under acidic conditions, the formaldehyde additive can also react with the electron-rich position para to the methoxy group in the aromatic ring of guaiacyl lignin.

Another way to increase the efficiency of the extraction and minimize condensation reactions is to use a physical protection strategy. Flow-through extraction, a method of continuous extraction, is especially efficient for matrices such as biomass, where components that are extracted in an early step are prone to undergo further reactions in the extract. There, an extraction cell is connected to a pump system that continuously provides new solvent into the cell. The extraction time is short and the sample is thereafter cooled down in a condenser. The principle follows classical continuous extraction concepts where the extraction liquid is less saturated, which is beneficial for efficient extraction and also limits further reactions in the dissolved fractions. It has previously been reported that β-O-4′ units are preserved to a higher degree when using the flow-through principle, making the lignin produced by this method more suitable for monomer production in a lignin biorefinery.

Lignin produced by current technology is heterogeneous, structurally very complicated and not directly suitable as precursor for material synthesis or biofuel additive. There is ongoing research on how make these lignins more homogeneous through refining, but this could be very expensive in large scale operations. Furthermore, hemicelluloses, an important fraction of lignocellulose are also currently not technically isolated. In most of the existing processes for fiber production, the hemicelluloses are degraded to small molecules and not recovered (burnt with lignin in the kraft process).

There is a need to further develop a mild green consolidated lignin extraction process with minimum lignin modification. Given the need for better material usage and circularity, consolidated biorefinery concepts, where value can be derived from all streams, are attractive.

### SUMMARY

One object of the present invention is to obviate at least some of the disadvantages in the prior art and provide a consolidated (integrated) biorefinery method to fractionate at least hemicellulose and lignin from lignocellulosic biomass, using green solvent system comprising water and ethanol and optionally including a small amount of inorganic acid. No additional additives are required to protect the lignin structures. Thereby a sustainable approach for the extraction of “native”-like lignin manifested by a high degree of β-O-4′ interunit linkage, a lower degree of condensation, high purity, and high yield is provided.

Accordingly, there is in a first aspect provided a method for extraction of hemicellulose, lignin and carbohydrates from a lignocellulosic biomass comprising hemicellulose, lignin, carbohydrates and fiber. The method comprises a step 1) of extracting hemicellulose from lignocellulosic biomass, which leaves a first fiber residue, and a step 2) of extracting lignin and carbohydrates from said first fiber residue, which leaves a second fiber residue.

Step 1) comprises providing (1a)) lignocellulosic biomass and a first solvent in a first container, the first solvent being subcritical water. The volume of the first solvent is such that a pressure of from atmospheric pressure up to 2000 psi is reached in said first container.

Step 1) further comprises heating (1b)) said biomass and first solvent to a temperature of 110-170° C., while maintaining a pressure in said first container of from atmospheric pressure up to 2000 psi.

Step 1) further comprises letting (1c)) said biomass and said first solvent be in contact, while maintaining a temperature of 110-170° C. in said first container as well as maintaining a pressure of from atmospheric pressure up to 2000 psi in said first container, for a period of time, so that at least a part of the hemicelluloses of the lignocellulosic biomass are extracted from the biomass, leaving a first fiber residue. This period of time may be 1-3 h, such as around 2 h.

Step 1) further comprises recovering (1d)) at least a part of said first solvent with at least part of the extracted hemicelluloses from said first container.

Step 2) comprises providing (2a)) said first fiber residue and a second solvent in a second container. The second solvent comprises ethanol and water. The volume of second solvent is such that a pressure of from atmospheric pressure up to 2000 psi is reached in the second container.

Step 2) further comprises heating (2b)) said first fiber residue and said second solvent to a temperature of 110-170° C., while maintaining the pressure in said second container at from atmospheric pressure up to 2000 psi. The pressure may for example be maintained at around the level reached in step 2a).

Step 2) further comprises letting (2c)) said first fiber residue and said second solvent be in contact, while maintaining a temperature of 110-170° C. and, and while maintaining a pressure in said second container of from atmospheric pressure up to 2000 psi, for a period of time such that at least a part of the lignin and at least part of the carbohydrates are extracted from said first fiber residue, leaving a second fiber residue.

Step 2) further comprises recovering (2d)) at least a part of said second solvent with at least part of the extracted lignin and carbohydrates from said second container. Step 2) further comprises optionally separating (2e)) the extracted carbohydrates and the extracted lignin in a washing step.

As most hemicelluloses have already been extracted in the hydrothermal extraction step 1), the porosity of the material (going from biomass to fiber residue) may be improved, resulting in faster kinetics and improved selectivity for the lignin extraction in step 2). The yield and purity of the extracted lignin is enhanced when the hemicellulose is first extracted as described. The obtained hemicellulose extract is oligomeric and still contains the native backbone decorations which include single sugar units branching off from the main chain, as well as O-acetyl decorations.

Such native hemicelluloses have potential in applications such as emulsions and could also be subsequently fermented to ethanol. In the latter case, the bioethanol produced could potentially be used in the subsequent organosolv extraction step described herein, thereby contributing to the circularity aspects of the process.

The optional washing step of step 2) may comprise filtering of the at least a part of said second solvent with at least part of the extracted lignin and carbohydrates recovered in step 2d). The washing step may be adapted depending on which lignin fraction that is wanted. A washing step may be important to provide a pure lignin fraction.

The lignocellulosic biomass comprising hemicellulose, lignin, carbohydrates and fiber may for example be wood. In one embodiment the lignocellulosic biomass is spruce wood chips.

Subcritical water or water and ethanol is selected as components in the first and second solvent, respectively, in consideration of the principles of green chemistry and circularity. Ethanol can be recovered by means of distillation, owing to its low boiling point, making it particularly practical from a recovery viewpoint compared to other organic solvents. Primary alcohols have shown more selective delignification than secondary and tertiary alcohols. The lower viscosity of organic solvents makes the solvent dispersion in biomass faster. The method can also be performed with catalysts as well as additives with different catalysts to enhance the extraction of lignin. Subcritical liquids, i.e. liquids where the temperature or pressure is slightly under the critical value, have the unique property of simultaneous low viscosity and high diffusivity. These properties enhance mass transfer and have advantages in addressing biomass recalcitrance to fractionation.

Atmospheric pressure is defined as 14, 696 psi. The pressure reached or maintained in step 1 and/or 2 may for example be in the range of 15 to 2000 psi, 300 to 1900 psi, 500 to 1700 psi, 700 to 1600 psi, 900 to 1600 psi, 1000 to 1600 psi, 1200 to 1600 psi, 1400 to 1600 psi or 1500 to 1600 psi.

The pressure may be maintained by pumping in more first or second solvent into the first and/or second container if the pressure is lower than desired and opening a static valve which is located after the first and/or second container if the pressure is higher than desired.

The method for extraction is based on maintaining a certain pressure and not the actual volumes of solvent delivered to the container. One consequence is that there may be some variation in the final volumes of the first or second solvent comprising extracts recovered in 1d) or 2d). This is partly due to the pressure dependence in the extraction, but also that parts of the biomass components may be continuously extracted and removed from the container. At high temperature and pressure, liquid is compressed and depending on the critical point of the solvent used, the condition can become sub- or supercritical. In these cases, the volume contained in the container is assumed to exceed the theoretical volume of the container.

If a volume of first solvent that was predetermined to be added to the first container in step 1a) was not added due to the pressure in the first container exceeding the desired pressure, this remaining volume may be added to the first solvent with at least part of the extracted hemicellulose recovered in step 1d).

The temperature reached in step 1b) and/or 2b) and maintained in step 1c) and/or 2c) may for example be in the range of 110-165° C., such as 140° C., or 150-170° C., such as around 160° C. The temperature range is chosen to be high enough for extraction of hemicellulose, lignin and carbohydrates, but is lower than those used in classical organosolv processes, such as the Alcell process, in order to provide a mild extraction method in which lignin modification is minimized.

Hemicelluloses extracted through this method are partially hydrolyzed but still contain glycosidic bonds and acetyl moieties, which are indicative of a mild extraction. When the extraction temperature is set to 160° C., the formation of pseudo-lignin from hemicellulose degradation products is negligible.

In one preferred embodiment of the method, the second container is the same container as the first container. The first fiber residue may in this case remain in said first container after step 1) and second solvent be introduced into said first container in step 2a).

In one embodiment of the method for extraction, step 1d) comprises at least one of the following steps:
recovering residual first solvent by applying pressurized gas, wherein the gas optionally is an inert gas; and
recovering residual first solvent by rinsing with water.

In one embodiment of the method for extraction, 2d) comprises at least one of the following steps:
recovering residual second solvent by applying pressurized gas, wherein the gas optionally is an inert gas; and
recovering residual second solvent by rinsing with ethanol.

Applying pressurized gas or rinsing with water or ethanol is be performed in order to remove as much of the first and/or second solvent and dissolved extracts as possible from the first and/or second fiber residue. In one embodiment the pressurized gas is applied for around 90 seconds. In one embodiment the pressurized gas is nitrogen gas.

In one embodiment of the method for extraction, the ratio of ethanol to water in the second solvent is between 60:40 (v/v) and 80:20 (v/v). In one embodiment the ratio is 70:30 (v/v). The ratio is chosen depending on the desired properties of the lignin.

In one embodiment of the method for extraction, said second solvent comprises a mineral acid. Small amounts of acid may be added to improve lignin purity. In one embodiment the mineral acid is sulfuric acid. In one embodiment the sulfuric acid is 0.5-2.5 wt %, such as 1.5 wt %, sulfuric acid. In an embodiment wherein the second solvent comprises a mineral acid, the second container comprises Zirconium, to avoid corrosion.

In one embodiment of the method for extraction, step 2c)-2d) comprises a plurality of static cycles, wherein each static cycle comprises the steps of:
6a) maintaining said first fiber residue and said second solvent in said second container at a temperature of 110-170° C. for a time period of from 1 to 20 minutes,
6b) introducing a volume X of new second solvent to said second container and simultaneously discharging the same volume X of the second solvent with at least at part of the extracted lignin from the second container.

In one embodiment, the number of static cycles is 2-20. In one embodiment, the number of static cycles is 5-15. In one embodiment, the number of static cycles is 9. In one embodiment, the number of static cycles is 15.

An advantage of extraction in short static cycles is that lignin modification which takes place when fiber residue is exposed to high temperatures for a longer period of time is avoided. The static cycle is an essential step to preserve the native structure of lignin, which would otherwise condense to form several complex structures that are not of technical interest. The set-up thereby provides a milder extraction method resulting in high quality lignin.

The volume X of second solvent introduced during one static cycles can be selected as a percentage of the volume Z of second solvent provided in step 2a). However, at high temperature and pressure, the solvent is compressed and depending on the composition of the solvent used, the condition can become sub- or supercritical, depending on the critical point of the solvent used. In these cases, the volume added to the container to reach a predetermined pressure is assumed to exceed the theoretical volume of the container. In one embodiment of the method for extraction, the volume X of new second solvent introduced and discharged during at least one static cycle is 10-30% (v/v) of the volume Z of the second solvent provided in step 2a). In one embodiment of the method, the volume X of new second solvent introduced and discharged during at least one static cycle is 18% (v/v) of the volume Z of the second solvent provided in step 2a). Thereby, not all the second solvent in the second container is replaced during a static cycle. One advantage of this is a lower consumption of second solvent. Another advantage is a shorter heating time.

In one embodiment of the method for extraction, the first and/or second solvent has a temperature of up to 170° C. when provided in step 1a) and/or 2a) and/or introduced in step 6b). In one embodiment the first and/or second solvent has a temperature of ambient temperature when provided in step 1a) and/or 2a) and/or introduced in step 6b). In one embodiment the first and/or second solvent has a temperature of 110-170° C. when provided in step 1a) and/or 2a) and/or introduced in step 6b). In one embodiment the first and/or second solvent has a temperature of 160° C. when provided in step 1a) and/or 2a) and/or introduced in step 6b). One advantage of preheating the first and/or second solvent is a more efficient initial extraction. Preheating could also shorten the necessary time period for the heating in step 1b) and/or 2b).

The lignin obtained in step 2) is in one embodiment further fractioned using ethanol.

The carbohydrates obtained in step 2) is in one embodiment hydrolyzed to monomeric sugars for further production of platform chemicals.

The carbohydrates obtained in step 2) is in one embodiment fermented to ethanol, which would not only be attractive for the organosolv process economics but could also support the circularity of the process if the produced ethanol was used internally.

The hemicellulose obtained in step 1) is in one embodiment hydrolyzed to monomeric sugars for further production of platform chemicals.

The hemicellulose obtained in step 1) is in one embodiment fermented to ethanol, which would not only be attractive for the organosolv process economics but could also support the circularity of the process if the produced ethanol was used internally.

In a second aspect, there is provided a lignin obtained by the method for extraction described above. The provided lignin has a high degree of β-O-4′ interunit linkage, low degree of condensation and high purity. The degree of β-O-4′ interunit linkage may be around 40%.

The second fiber residue is cellulose-rich and could also be used in a similar way to the hemicellulose extract described above. Alternatively, fiber-based composites are becoming attractive and the presence of lignin in the fibers has been shown to enhance the thermomechanical properties of such materials. Based on the lignin content of the fiber residue, such potential applications could be investigated.

The lignin could be used directly as a polymer precursor for material synthesis or catalytically depolymerized to platform monomers. Based on their functionality, structure, low degree of polymerization (DPn) and demonstrably narrow polydispersity index (Ð), these lignins might be suitable as polymer precursors for the synthesis of thermosetting resins, as shown in recent studies. Oligomeric fractions have been shown to be preferable to polymeric fractions for the synthesis of homogeneous materials, due to their mutual solubility with other chemical components used in the synthesis.

The cyclically extracted lignin is also an attractive precursor for platform monomers. In this context, catalytic depolymerization is favored because of the high aryl ether content of the extracted lignin. In recent years, innovative methods for conversion of lignin into platform monomers have emerged and include reductive catalytic fractionation (RCF) and base-catalyzed depolymerization (BCD).

Although the present invention has been described above with reference to specific embodiments, it is not intended to be limited to the specific form set forth herein. Rather, the invention is limited only by the accompanying claims and other embodiments than the specific embodiments described above are equally possible within the scope of these appended claims.

In the claims, the term “comprises/comprising” does not exclude the presence of other elements or steps.

Additionally, although individual features may be included in different claims, these may possibly advantageously be combined, and the inclusion in different claims does not imply that a combination of features is not feasible and/or advantageous.

In addition, singular references do not exclude a plurality. The terms “a”, “an”, “first”, “second” etc. do not preclude a plurality.

### BRIEF DESCRIPTION OF THE DRAWINGS

These and other aspects, features and advantages of which the invention is capable of will be apparent and elucidated from the following description of embodiments of the present invention, reference being made to the accompanying drawings, in which:

FIG. 1 shows a schematic representation of a method for extraction of hemicellulose, lignin and carbohydrates from a lignocellulosic biomass and the extracts obtained in said method.

FIG. 2 shows an HSQC NMR spectra of the hydrothermal extract. f1: ¹³C, f2: ¹H. Subscripts indicate the carbon number in accordance with saccharide nomenclature; M=mannan; X=xylan; Ac represents O-acetylated carbons; Red=reducing end; Non-red=nonreducing end.

FIG. 3 shows lignin interunit linkages and substructures from the extraction procedure.

FIG. 4 shows HSQC spectra for reference organosolv extractions. Reaction conditions: 2 h, 160° C., 1.5 wt % sulfuric acid extraction. f1: ¹³C, f2: ¹H. Figures are labeled according to the structures depicted in FIG. 3.

FIG. 5 shows yield trend for cyclic extraction using 0.5 wt % acid.

FIG. 6 shows yield trend for cyclic extraction using 1.5 wt % acid.

FIG. 7 shows ³¹P NMR spectroscopy: Extraction trends in static cycles using 1.5 wt % acid.

FIG. 8 shows a comparison of hydroxy functionalities between the integrated cyclic extraction method (1.5% acid series) and the 2 h organosolv extraction method.

FIG. 9 shows an HSQC spectra for integrated cyclic extraction method. f1: ¹³C, f2: ¹H. The figures are labeled according to the structures depicted in FIG. 3.

FIG. 10 shows the trend of the interunit linkage content of β-O-4′ and β-5′ interpreted from HSQC. Ca indicates the alpha carbon on the benzylic chain of the lignin molecule, both with hydroxy and ethyl substitution.

FIG. 11 shows trends in size-exclusion chromatography using 1.5 wt % acid, fractions 1-10.

FIG. 12 shows photographs of lignin fractions. 1) Reference extraction of 2 h and 3 h, respectively. 2) 1.5 wt % acid extraction series of ten fractions; left to right: fractions 1-5 and fraction 10. The images are taken with white copy paper as the background.

FIG. 13 shows A) Lignin reactions during static cycle extraction. B) Lignin reactions during prolonged batch extraction.

FIG. 14 shows schematic representation of the method for extraction.

FIG. 15 is Table 1, showing quantification of interunit linkages, substructures and total extraction yield. All interunit linkages and substructures are semi-quantified per 100 Ar units. For the 0.5% and 1.5% acid series, values are presented as mean±SD where n=9 and n=5 [a] for the 0.5% series. The number of n reflects the number of collected fractions in the trend series investigation. For the 1.5% series, n=5. The high SD for the β-1′ stilbene structures can be attributed to a downward trend and for the β-5′ stilbene structures an upward trend from the first to the last fraction.

FIG. 16 is Table 2, showing fractionation of cyclic extracted lignin. The yield is given as relative mass % to the total amount of extracted lignin.

FIG. 17 is Table 3, showing compositions and Mass balances of the consolidated biorefinery components presented as dry mass %.

### DETAILED DESCRIPTION

The invention relates to a method for extraction of hemicellulose, lignin and carbohydrates from a lignocellulosic biomass comprising hemicellulose, lignin, carbohydrates and fiber, schematically shown in FIG. 1.

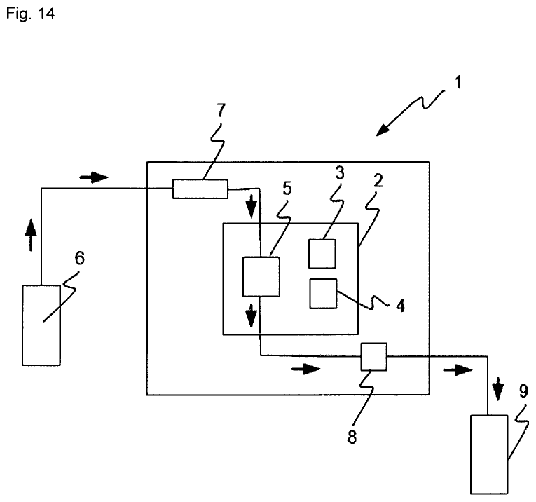

With reference to FIG. 14, the method for extraction is in one embodiment performed be means of an instrument provided with an integrated temperature control 3 and an integrated pressure regulator 4, such as an Accelerated Solvent Extractor (ASE) instrument 1. The method for extraction may for example be performed by means of an ASE 1 according to the following description: An integrated oven 2 in the ASE 1 is heated to around 160° C.

Step 1) When the oven 2 has reached around 160° C., a 66 mL container 5 containing lignocellulosic biomass is transported via a carousel and arm into the integrated oven 2. A predetermined volume of first solvent, being subcritical water, at ambient temperature, is pumped by means of a pump 7 into the container 5 such that a pressure of 1500-1600 psi is reached. The container 5 is maintained in the oven 2 for a time period of 8 minutes. To pressurize the container, a static valve 8 which is located after the container 5 is closed. During the 8 minutes of heating, the first solvent expands and to relieve pressure, if the pressure exceeds 1600 psi, the static valve 8 is opened.

The lignocellulosic biomass and first solvent are maintained in the container 5, which is maintained in the oven 2 at a temperature of around 160° C., for a time period of 2 h, during which lignocellulosic biomass and first solvent is in contact, whereby hemicellulose is extracted, leaving a first fiber residue. After the 2 h, at least a part of the first solvent with at least part of the extracted hemicellulose is recovered from said first container 5. If not the whole predetermined volume of first solvent could be added before the pressure in the container 5 reached 1600 psi, the residual volume of first solvent is instead added to the recovered content at this step. Residual liquid content (first solvent with at least part of the extracted hemicellulose) is drained from the container 5 and to recover as much content as possible from the container 5, pressurized nitrogen gas is applied, for around 90 seconds.

Step 2) The same container 5, containing obtained first fiber residue, is transported via the carousel and arm into the oven 2, which has a temperature of around 160° C. A volume Z of second solvent, comprising ethanol and water at a ratio of 70:30 (v/v) and 1.5 wt % sulfuric acid, being at ambient temperature, is pumped by means of a pump 7 into the container 5 until the pressure reaches 1500-1600 psi. To pressurize the container 5, the static valve 8 is closed. During heating, the second solvent expands. If the pressure exceeds 1600 psi, the static valve 8 opens and to relieve pressure. If the pressure gets too low, more second solvent is pumped into the container 5 to maintain the pressure of 1500-1600 psi.

The container 5 is maintained in the oven 2 at a temperature of 160° C. for a time period of 8 minutes. Immediately after this heating step, a first static cycle starts. The first fiber residue and second solvent are maintained in the container 5, which is maintained in the oven 2 at a temperature of around 160° C., for a time period of 5 minutes, during which the first fiber residue and second solvent is in contact, whereby lignin and carbohydrates are extracted, leaving a second fiber residue. After the 5 minutes, the static valve 8 opens and a predetermined volume X of new second solvent is pumped by means of a pump 7 into the container 5 while the same volume X of the content of the container 5 (i.e. second solvent with at least part of the extracted lignin and carbohydrates) is simultaneously discharged from the container 5 into a collection bottle 9. The volume added and simultaneously discharged may vary between cycles. During the last cycle, residual liquid content (second solvent with at least part of the extracted lignin and carbohydrates) is drained and to recover as much content as possible from the container 5, pressurized nitrogen gas is applied, for around 90 seconds.

### Experiments

### Hydrothermal Extract (Hemicellulose) and Final Fiber Residue (Second Fiber Residue)

Extraction was performed according to claim 1.

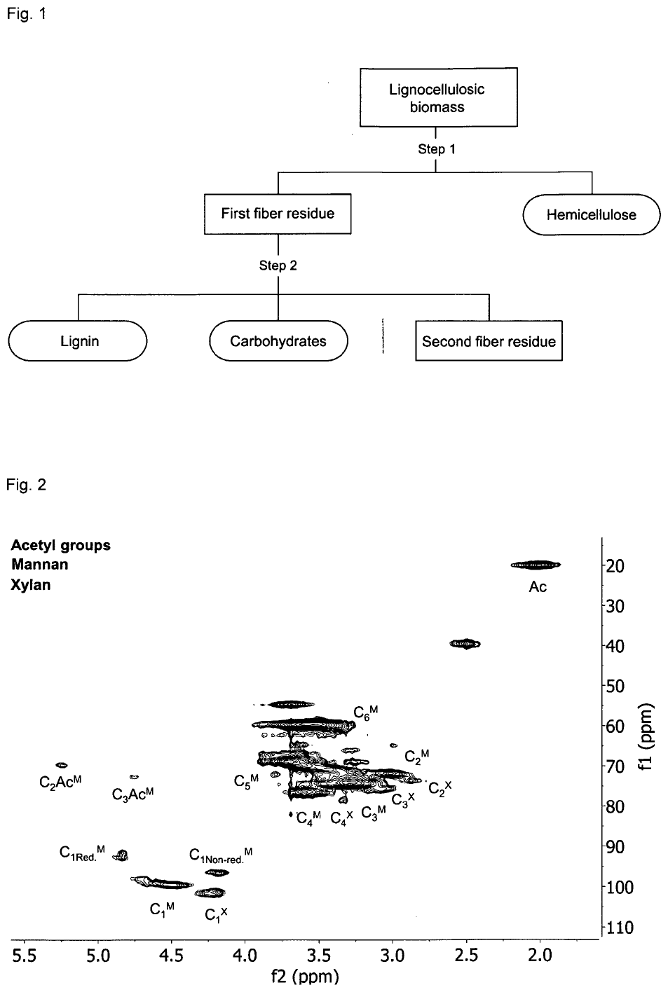

The molecular weight distribution was studied by size-exclusion chromatography. Two populations were observed with respect to molar mass. In the higher molar mass fraction, which accounted for 61% of the chromatogram area, Mₙ and M_{w} were 1050 and 3050, respectively, and the dispersity index (Ð) was 2.9. The approximate degree of polymerization (DPₙ) as determined by using the anhydromannose unit (162 gmol⁻¹) as a repeating unit, was about 6-7. The HSQC spectra of the hemicelluloses extracted in the present study (FIG. 2) display native structures indicative of a mild extraction in the form of partially O-acetylated C2 and C3 hydroxy groups.

Taken together, the SEC and HSQC data suggest that the native hemicelluloses are partially hydrolyzed at the glycosidic bond but that the resulting oligomers have preserved their native structures.

The final fiber residue (second fiber residue) was also analyzed by X-ray diffraction (XRD) and, as expected, the crystallinity of cellulose was retained after both extraction steps.

### Organosolv (Aqueous Ethanol) Extraction Method

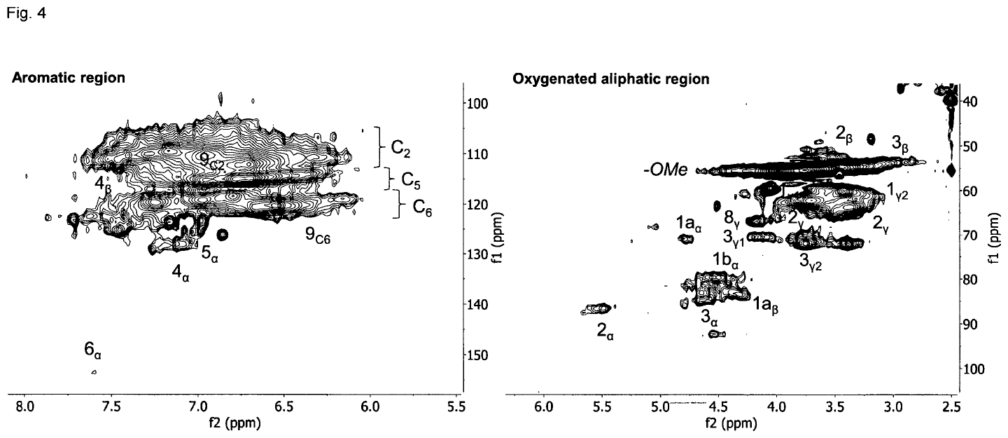

Two reference organosolv extractions were performed with extraction times of 2 h (FIG. 4) and 3 h at 160° C. with 1.5 wt % sulfuric acid. These conditions reflect common time scales and temperatures for organosolv extractions. The difference here is that most of the hemicelluloses have already been extracted in a hydrothermal extraction step. This may improve the porosity of the material, resulting in faster kinetics and improved selectivity for the lignin extraction. The contents of B-aryl ether linkages (β-O-4′) and other common native linkages were analyzed by HSQC, as an indicator of the mildness of the extraction.

The two reference samples showed, as is typical for most organosolv processes, low contents of β-O-4′ bonds (at 7% for the 2 h sample and 4% for the 3 h sample; Table 1). In contrast, the β-O-4′ content of native spruce lignin has been reported to be in the order of 35-60%. Nevertheless, the β-O-4′ bonds appeared to be both hydroxylated and etherified at Ca, in agreement with reported results. Such etherification reactions occur through addition reactions of ethanol to electrophilic benzylic cations and have been postulated to improve the solubility of lignin in ethanol. Under the 2 h and 3 h extraction conditions, 64% and 100% of the β-O-4′ structures were etherified, respectively. Interestingly, strong signals were observed at 6.7/112.5 ppm and 6.6/120.5 ppm, typical of C2Ar—H and C6Ar—H correlations, respectively, in 5-5′ condensed subunits. This was further substantiated by HMBC. These signals were not as intense in milled wood lignins (MWL) prepared from the original wood and the fibers after subcritical water extraction (fiber residue A, FIG. 1). This suggested that some lignin condensation reactions occurred during the 2 h and 3 h organosolv extractions. In contrast, signals from noncondensed C5Ar structures were relatively weak in the organosolv lignins. These structures are analyzed indirectly by the drift they cause to C2Ar—H and C6Ar—H chemical shifts, which then appear at 6.92/110.5 ppm and 6.8/118.5 ppm, respectively. The formation of 5-5′ structures cannot occur through acid-catalyzed condensation under the prevailing conditions since the free aromatic sites are known to be electron-rich.

### Cyclic Extraction Method

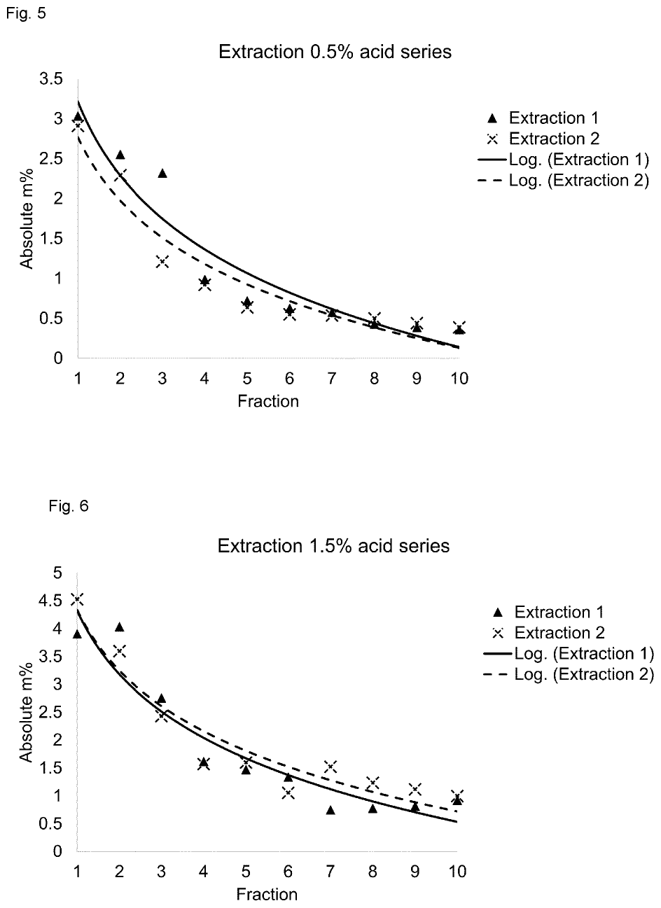

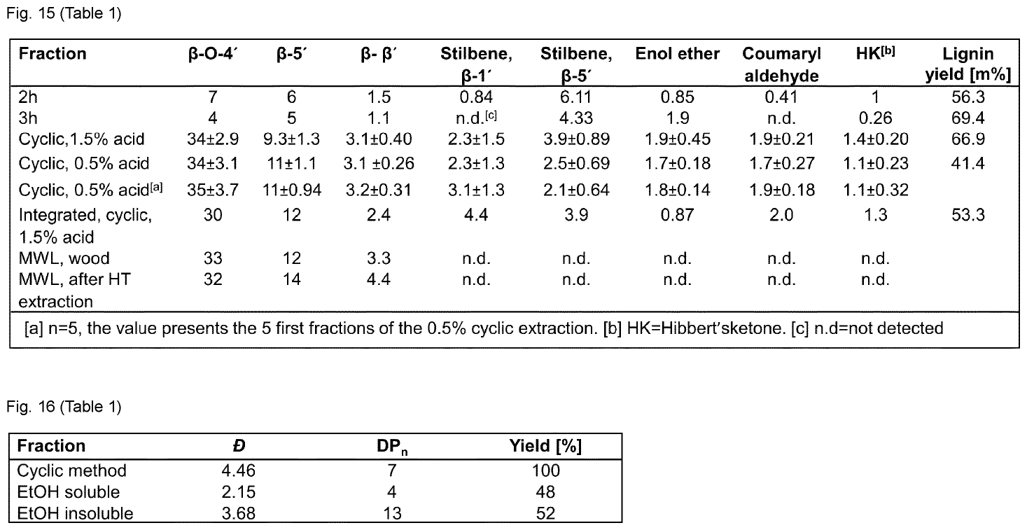

Static cycles consisting of 5 min aqueous ethanol extractions at 160° C., using two sulfuric acid concentrations (0.5 and 1.5 wt %), were performed on the subcritical water-extracted fiber residue. The obtained lignins were analyzed for yield, hydroxy functionality (using ³¹P NMR spectroscopy), lignin structure (using 2D NMR techniques) and molecular weight distribution (using SEC). Yield analysis showed that the highest quantity of lignin was extracted during the earlier cycles (FIGS. 5 and 6) with a steep decline in efficiency from cycle 1 to 4. When compared to the longer 2 h reference extractions described earlier, the yields (56.3%, FIG. 15 (Table 1)) are in the same regime, indicating that the kinetics of lignin extraction are improved when using the cyclic method. This might be explained by saturation being impeded by the periodical exchange of solution for fresh solvent, which enhances the extraction.

The results of ³¹P NMR spectroscopy (FIG. 7), show a relatively high content of aliphatic hydroxy groups in the earlier part of the cycle, suggesting that the native aliphatic side-chain configuration is quite well preserved. In native wood lignins, Cα and Cγ are mostly hydroxylated, the latter to a higher degree than the former. The content of aliphatic hydroxyl groups seems to decrease with increasing cycle number, indicating side-chain reactions.

The content of noncondensed phenolic hydroxy groups decreases slightly and then seems to level off as the cycle number increases. This suggests that lignin depolymerization, which normally occurs through aryl ether cleavage, is not significant when using the static cycle method. In contrast, the content of C5-condensed phenolic hydroxyl groups increases slightly at the beginning of the cycle then level off.

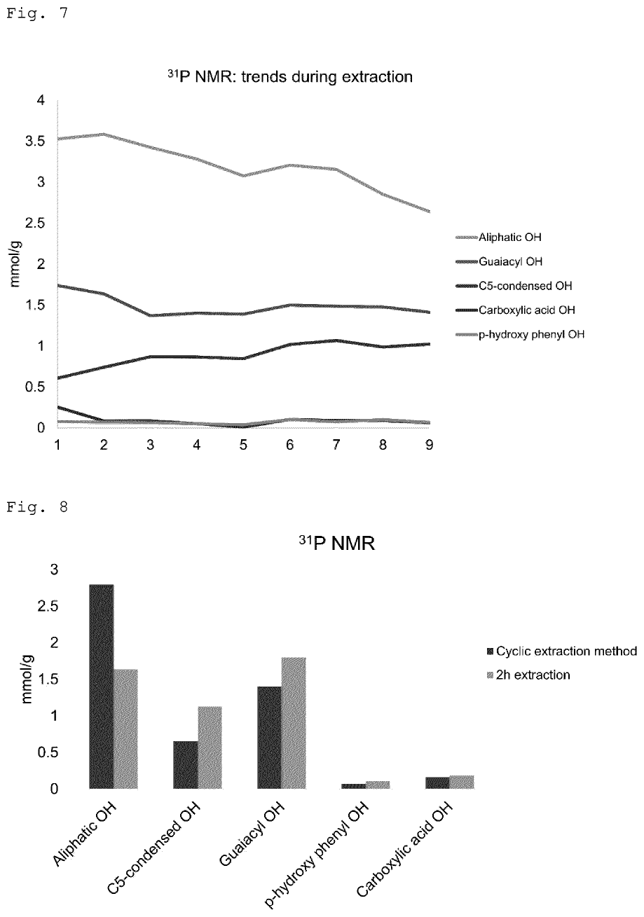

A comparison between the hydroxy functionalities of the lignin obtained by the integrated (average values) cyclic extraction method and that obtained from the 2 h organosolv extraction is shown in FIG. 8. The 2 h extracted lignin is found to have a lower aliphatic hydroxy content and a higher phenolic hydroxy content; these observations are consistent with the occurrence of side-chain reactions and the cleavage of aryl ether linkages, respectively.

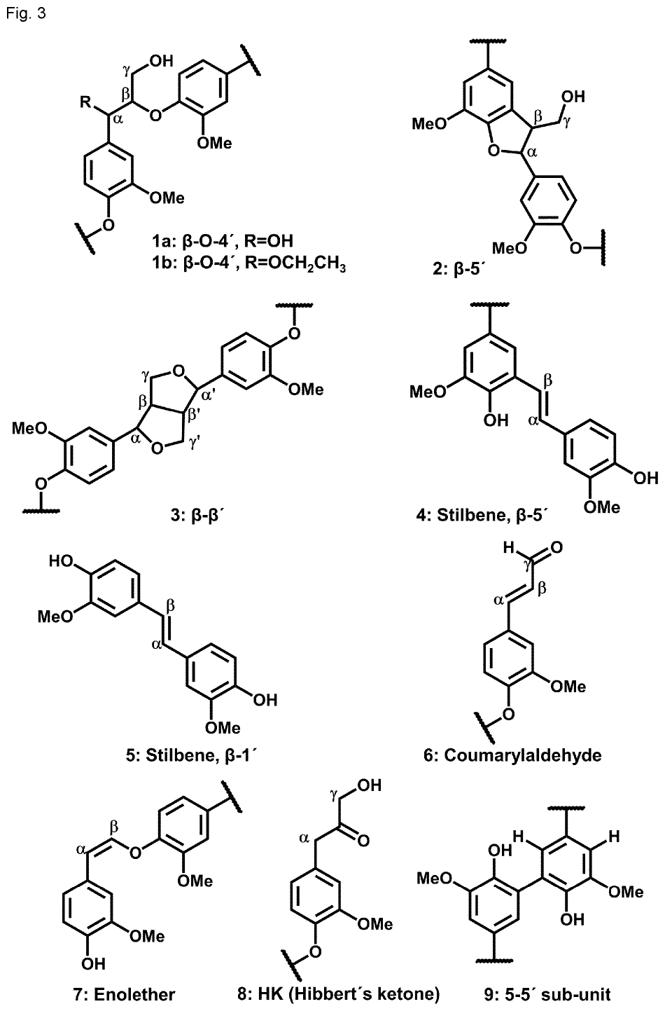

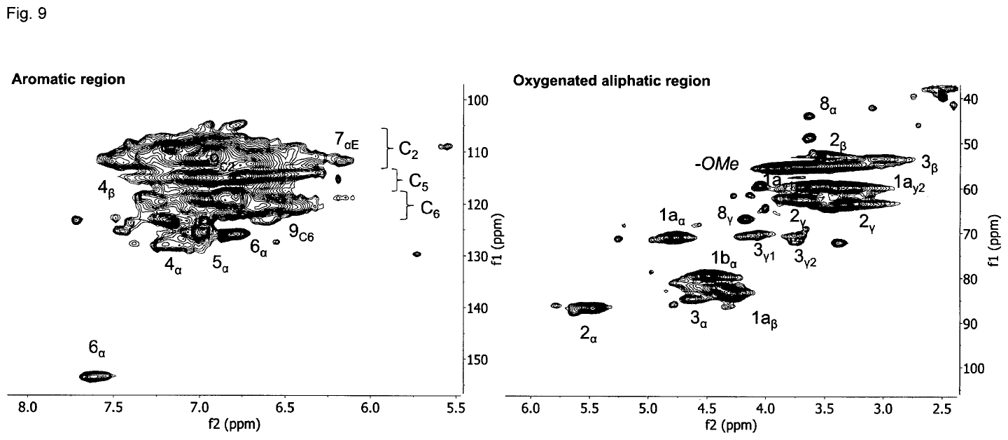

The native interunit linkages in the pooled cyclic extracted lignins (together with other linkages; see FIG. 3) were investigated by HSQC (FIG. 9). The previously discussed signals relating to 5-5′ condensation products—C2Ar—H and C6Ar—H appearing at 6.7/112.5 ppm and 6.6/120.5 ppm, respectively—were compared between the cyclic series (FIG. 9) and the reference samples. Stronger signals in support of the condensation reaction could be observed in the reference samples, consistent with the ³¹P NMR results (FIG. 8). In addition, β-O-4′ bonds are present in both a-hydroxylated and etherified forms.

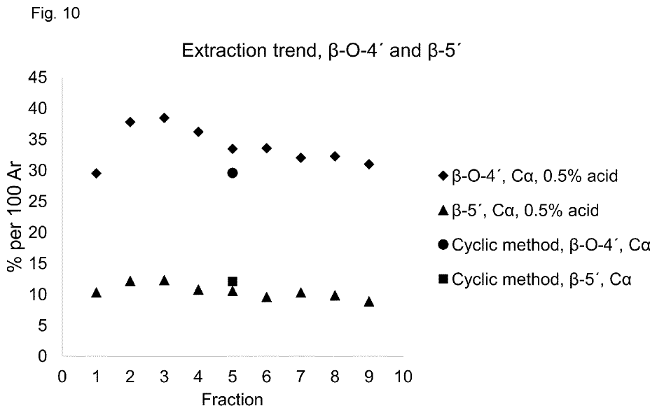

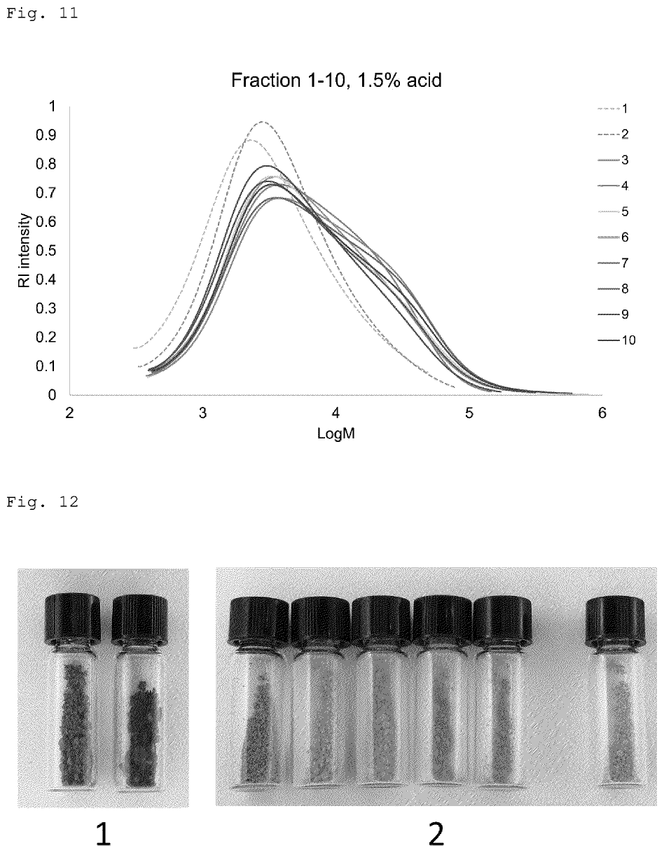

The trends of β-O-4′ and β b-5′ concentrations from the 0.5% acid study and the final cyclic method are compared in FIG. 10. From fractions 2 to 9 in the trend study, β-O-4′ concentrations are seen to decrease slightly, but are still in the region of 30-38 per 100 aromatic rings, and are significantly higher compared to the aforementioned organosolv reference with around 7 per 100 aromatic rings. In fact, the β-O-4′ amounts in the cyclic series are at similar levels to those of milled wood lignins (MWL) prepared from both the original wood and the subcritical water-extracted wood meals used in this study. High yields of lignin with good preservation of native structures using static cycles can thus be substantiated. The mildness of the extraction is also manifested in the detection of dibenzodioxocin and trace amounts of spirodienone structures, which are traditionally easily modified or degraded during extraction.

SEC was conducted on the cyclic fractions (FIG. 11). It is seen from the chromatograms that the lignin from the first two cycles have a single distribution while the lignins from the third cycle and upwards show overlapping chromatograms. The polydispersity index Ð is 3.0-4.8 and the DPₙ is 9-19 for the ten cyclic fractions. Except for the first three cycles, there is no linear trend in molecular weight.

From ocular inspection, we observed that the lignin fractions have different colors and that the more “native”-like lignin fractions obtained by the cyclic method appear paler, with a light beige color, compared to the reference organosolv lignins extracted at 2 h and 3 h, which have a significantly darker color (FIG. 12). This difference in color is probably due to a higher degree of lignin condensation in the reference lignins. Interestingly, the first sample in the cyclic lignins sticks out in being slightly darker than the rest. This could be explained by the presence of extractives in this first cycle. From the HSQC, signals from extractives were more prominent in this fraction than the subsequent ones. These signals appear in the nonoxygenated aliphatic regions. HMBC analysis substantiated the presence of unsaturated fatty acids or esters. The 0.5% acid series fractions followed the same color patterns as the 1.5% series.

For practical reasons, the cyclic method was further developed as an integrated method, that is, all cycles were pooled. For this purpose, the 1.5% acid series was chosen over the 0.5% acid series. This was due to the higher lignin yield, although the β-O-4′ content was slightly lower, FIG. 15 (Table 1). The final integrated cyclic method (FIG. 9) reflects an average of interunit linkages from all previous cycle series with a β-O-4′ content of 30% and a β-5′ content of 12% (FIG. 15 (Table 1)).

### Fractionation for Narrow Polydispersity

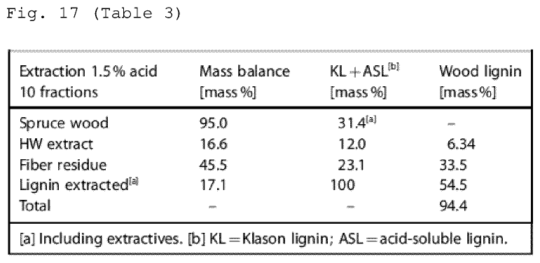

The sample obtained from the integrated cyclic method was studied by SEC and shown to have a DPₙ of around 7 and Ð of 4.4 (FIG. 16 (Table 2)). In general, low Ð values are preferred if such lignins are to be used directly as polymer precursors. The crude fractions obtained here could require further refining due to their high Ð values. To decrease Ð, fractionation with ethanol (99%) was investigated and found to be efficient. Two fractions were obtained: an ethanol-soluble fraction and an ethanol-insoluble fraction, with yields of 48% and 52%, respectively, and Ð values of 2.1 and 3.6, respectively (FIG. 16 (Table 2)). The insoluble fraction had a higher molecular weight than the soluble fraction, yet, interestingly, both fractions had a similar content of β-O-4′ bonds, at 30%.

³¹P NMR spectroscopy show that the C5-condensed phenolic content is lower for the ethanol-soluble fraction than for the insoluble fraction, as well as for the unfractionated lignin sample. Fractions 1 and 2 from the 1.5% acid cyclic series were studied in a similar fashion. In both cases, the initial Ð was reduced for the ethanol-soluble fractions. A similar trend was observed for fraction 2.

Overall, narrow Ð values were successfully obtained by post-fractionation using ethanol as a sustainable solvent.

### Reaction Mechanisms

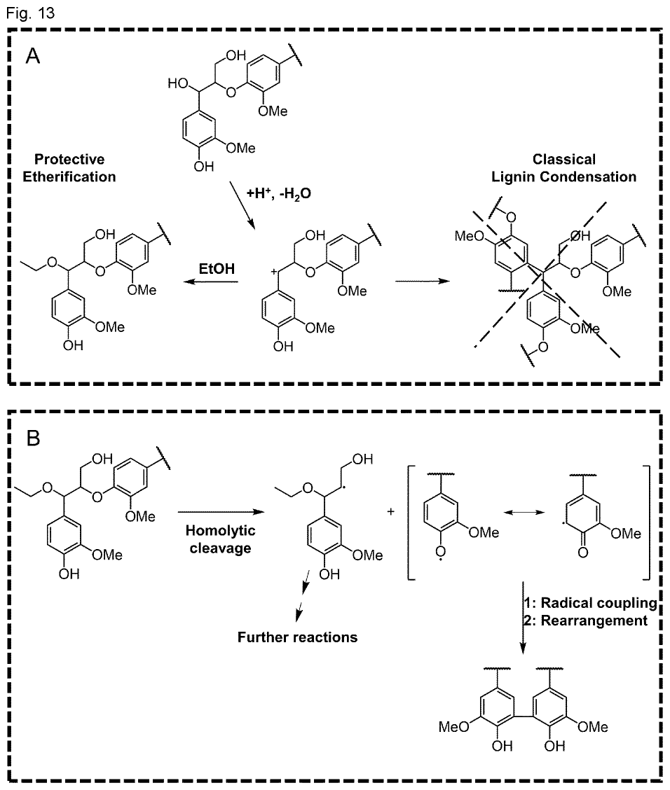

From the results presented so far, a few points stand out to reveal insights into a mechanistic understanding of the extraction process. These will now be discussed. When comparing the lignins obtained through short cycles with the reference (2 h) extractions, it is observed that the degrees of Cα etherification in β-O-4′ structures are similar (60-65% etherified, whereas the rest are hydroxylated). In the 3 h reference, by contrast, the degree of Cα etherification in β-O-4′ structures is almost 100%. These observations suggest that etherification takes place continually under acidic conditions and that the formed ethers are stable. Interestingly, the β-O-4′ contents are significantly different (30-38% levels in cyclic method compared with 4-7% in references), suggesting that Cα etherification does not protect the β-O-4′ structures from cleavage reactions. On the contrary, etherification may provide chemical protection from lignin condensation reactions by means of capping the benzylic cation with ethanol. β-O-4′ structures are physically protected through the developed cyclic extraction processing strategy. The physical protection results from the periodic removal of the dissolved components from the reactor to ambient conditions. In this way, the dissolved molecules are not exposed to the reaction conditions for a long duration, thereby limiting further reactions. The lignin reactions that do take place during the short residence time in the cycle are shown in FIG. 13A. In addition, the solute concentration is maintained at a low level, owing to displacement with fresh solvent. This results in a lower probability of occurrence of lignin condensation reactions, which would require molecular collisions.

Analysis of the number average molar mass (Mₙ) of the lignin fractions obtained by the cyclic methods suggests some differences, yet the β-O-4′ contents of these fractions are the same. A similar observation can be made from the lignin that was refined further by ethanol. In fact, analysis of the DPₙ of these refined fractions (FIG. 16 (Table 2)) shows a threefold difference. This suggests that condensation reactions between fractions with similar content of β-O-4′ structures take place. The content of β-0-4′ structures in the formed molecule resulting from such condensations would be the same. Several types of condensation reactions could potentially occur under acidic conditions. HSQC analysis showed the presence of stilbene structures, which are formed from the elimination of formaldehyde in phenylcoumaran (b-5′) and spirodienone (β-1′) structures. This formaldehyde could participate in condensation reactions involving the electron-rich position para to the methoxy group. However, no signals in the HSQC spectra that would attest to the formation of a methylene bridge in the resultant product could be identified. On the other hand, the 5-5′ couplings showed a stronger signal in the reference organosolv lignins when compared to milled wood lignins (MWL) from the original wood meal and the subcritical water extracted residues. This indicated that these bonds were also formed during the organosolv conditions. Without wishing to bound by any particular scientific theory the inventors propose a mechanism for how these are formed. This is indicated in FIG. 13B. Prolonged exposure of the dissolved lignin to the high extraction temperature induced homolytic cleavage of some labile β-O-4′ linkages resulting in the simultaneous formation of beta radicals and phenoxy radicals. The phenoxy radicals resonate to C5 radical structures, which couple to form stable 5-5′ linkages.

Apart from the 5-5′ couplings seen in the HSQC analysis, the formation of C5-condensed phenolics is further supported by ³¹P NMR spectroscopy for the cyclic extracted lignin samples (FIG. 7), where an increasing trend is observed. Substantiation of the proposed mechanism is even more clearly consistent with our observations that the lignins obtained through the static cycle approach have a significantly higher β-O-4′ content and lower content of 5-5′ structures, when compared to the 2 h and 3 h extractions.

Another possible reaction is the cleavage of β-O-4′ structures by heterolysis, but this would result in the formation of Hibbert's ketones, which were only detected in small amounts by the HSQC analysis (FIG. 15 (Table 1)). Homolysis therefore seems to be the main reaction pathway for the cleavage of β-O-4′ structures, subsequently followed by radical recoupling reactions to form 5-5′ condensed structures (FIG. 13). Such reactions are more prominent in the reference organosolv (2 h and 3 h extractions) and can be minimized by adopting the cyclic method approach. The temperature dependence of homolytic cleavage of β-O-4′ structures has been reported and the temperature used here falls in that regime (above 130° C.). The occurrence of radical repolymerization, in accordance with the described mechanism, is also supported by the SEC data, which shows that the 2 h-extracted lignins are in the same molecular weight regime as the pooled cyclic extracted lignins, albeit with approximately fourfold lower β-O-4′ content.

Chemical Composition and Mass Balance of the Biopolymer from the Consolidated Biorefinery

The analysis was performed on the Wiley-milled wood, hydrothermal extract, and the fiber residue after hot water and organosolv extraction. The mass balance of the extracted samples is given in Table 3 (FIG. 17). The lignin balance for the 1.5% acid series shows that roughly 6% of the lignin ends up in the subcritical water extract that contains the bulk of hemicellulose, 55% of the lignin ends up in the organosolv-obtained pure lignin fraction, and 34% of the lignin remains in the residual fiber fraction (see FIG. 1). Thus, 94% of the lignin balance is accounted for and the remaining part is probably lost during purification as water soluble fractions for example, as lignin carbohydrates complexes. Roughly 83% of the total wood mass balance is accounted for in the obtained fractions. The missing fractions are most likely small water-soluble molecules that were not recovered. These include hemicellulose-derived components, such as O-acetyl groups and monomeric sugars, that result from autohydrolysis during the subcritical water extraction step and acid catalyzed hydrolysis in the subsequent organosolv extraction step. Recovery processes for such molecules will be critical for future processes.

### Conclusions of the Experiments

The static cycle extraction approach was found to be key to the fulfillment of the preset criteria of obtaining native-like lignins in high yield and purity thanks to the minimization of lignin condensation reactions in this setup. The static cycle method was contrasted with a classical reference ethanol-water extraction performed under the same conditions but differentiated by an unperturbed longer extraction time. Lignin condensation reactions were found to be significant in the latter method and yielded stable 5-5′ bonds. The associated condensation mechanism is proposed to start with a homolytic cleavage of aryl ether linkages forming phenoxy radicals, as well as beta radicals. The former radicals have resonance structures with radicals at position C5, which in turn can couple to form stable C—C bonds. The typically expected lignin condensations at the benzylic cation under acidic conditions did not occur, which is in part explained by a chemical protection through capping by etherification with ethanol. Furthermore, no condensation products of lignin involving formaldehyde (which is released when stilbenes are formed) could be detected.

### Experiment Set-Up Details

### Chemicals

Wood chips were obtained from Norway spruce (Picea abies). The water used in the experiment was in all cases Milli-Q water (Millipore, Q-POD, Millipak 0.22 μm filter). Ethanol (absolute) and acetone were purchased from VWR chemicals, sulfuric acid (≥95%, analytical grade) from Fischer chemicals, and lithium bromide (reagent grade, ≥99%) from Honeywell. Dimethyl sulfoxide (anhydrous, ≥99.9%), [D₆] DMSO (99.9 at. % D), N, N-dimethylformamide (anhydrous, 99.8%), pyridine (anhydrous, 99.8%), endo-N-hydroxy-5-norbornene-2,3-dicarboximide (eHNDI; 97%), chromium (III) acetylacetonate (Cr(acac₃); 99.99%), 2-chloro-4,4,5,5-tetramethyl-1,3,2-dioxaphospholane (C1-TMDP; 95%), CDCl3 (≥99.8 at. % D), sodium acetate (anhydrous, ≥99.0%) and sodium hydroxide (50% in H₂O) were purchased from Sigma-Aldrich. Pullulan standards 342 to 708×103 Da were procured from Polymer Standard Service, Mainz, Germany.

### Material

The debarked wood was milled by using a Wiley mini mill (3383-L70, Thomas Scientific). The extraction was performed by using an ASE 350 Accelerated Solvent Extractor (Dionex, Sunnyvale, CA, USA). The samples were placed in Dionium Extraction cells, 34 mL (Stainless steel extraction cells) or 66 mL (Dionium extraction cells) in size, containing a glass fiber filter. The extract was collected in 250 mL collection bottles. Extraction filters (Duran filter funnel, diameter 60 mm, 10-16 microns) were purchased from Sigma-Aldrich. The molecular weight distribution and dispersity indices were investigated by using a size-exclusion chromatography system using refraction index detection (SECurity 1260, Polymer Standards Service, Mainz, Germany). The system included an autosampler (G1329B), an isocratic pump (G1310B), and an RI detector (G1362A). The system was equipped with GRAM columns (Polymer Standard Service, Mainz, Germany) in a series of precolumn (10 mm, 8×50 mm), PSS GRAM 10 000 Å, and 100 Å (10 mm, 8x 300 mm) columns. The data were processed by using the software PSS WinGPC UniChrom (Polymer Standard Service, Mainz, Germany). The carbohydrate analysis was performed by using an HPAEC/PAD ICS-3000 system (Dionex, Sunnyvale, CA, USA) equipped with a CarboPac PA-1 (Dionex, Sunnyvale, CA, USA) column (4×250 mm). The data was processed with Chromeleon 7.1 (Dionex, Sunnyvale, CA, USA). NMR spectroscopy was carried out on a Bruker NMR spectrometer 400 DMX (Bruker Corporation, Billerica, MA, USA) and Bruker NMR spectrometer Avance III HD 400 MHZ (Bruker Corporation, Billerica, MA, USA). Data was analyzed by MestreNova (v.9.0.0, Mestrelab Research).

### Methods

Spruce wood chips were first debarked and ocularly examined, where only bright wood without defects was collected. The wood chips were then Wiley-milled to 40 mesh. All the following wood meal weights are given on oven-dry basis. Since ASE instruments are programmed to keep a certain pressure, the exact amount of liquid is not constant in the static cycles using the standard method. Another consideration is that wood components are continuously removed in the cyclic extraction, inducing a continuous change in the liquid/wood (L/W) ratio. However, the L/W ratio is still roughly estimated in the following sections presented below.

The extraction process is divided into three sections. 1) A reference sample extraction; 2) an investigation of extraction trends and properties of the lignin fractions; 3) development of a cyclic extraction method for lignin:

1) Wiley-milled wood (3.8 g) was placed into a 34 mL stainless steel extraction cell. In the first step, a 2 h hot water extraction (HW) was performed followed by a second step comprising an organosolv extraction for 2 or 3 h. Instrument parameters were as follows: 160° C., a fixed volume of 40 mL, and a purge time of 90 s was used for both the HW and the organosolv extraction. The extraction was performed at a pressure of 1500-1600 psi. The samples were extracted with a solvent system composed of 1.5 wt % H₂SO₄ in an aqueous ethanol solution (30:70 v/v). For the HW extraction, the L/W ratio was 10.5. The L/W ratio for the organosolv extraction was estimated to be 14.

2) Extraction series were made for H₂SO₄ additions of both 1.5 wt % and 0.5 wt % to a binary solvent aqueous ethanol solution (30:70v/v) system. For the 1.5 wt % acid series, Wiley-milled wood (4.80 g) was placed into a 34 mL extraction cell. A HW extraction was performed for 2 h, at 160° C., using a fixed volume of 40 mL with a purge time of 90 s followed by an organosolv extraction which was performed 10 times for 5 min each at 160° C., with a fixed volume of 40 mL and using a purge time of 90 s. For the HW extraction, the L/W ratio was 8, whereas that for the organosolv extraction was estimated to by 11 for the first fraction and 13 for the last. For the 0.5 wt % extraction procedure, 10.1 g of wood was placed in a 66 mL Dionium extraction cell. The parameters for the HW extraction was 2 h of extraction, 160° C., a fixed volume of 70 mL and a purge time of 90 s. The organosolv extraction was performed 10 times for 5 min each, at 160° C. with a fixed volume of 60 mL and a purge time of 90 s. After each 5 min extraction, the extract was collected for further sample preparation. For the HW extraction, the L/W ratio was 7. The L/W ratio for the organosolv extraction was estimated to be 9 for the first fraction and 11 for the last.

3) Wiley-milled wood (9.3 g) was placed in a 66 mL Dionium extraction cell. The amount of wood meal was linearly scaled up from the 1.5 wt % acid method [described in (2)] using 34 mL cells to the 66 mL extraction cells. First, a HW extraction of 2 h extraction at 160° C. using a fixed volume of 70 mL and a purge time of 90 s was performed. The subsequent organosolv extraction was immediately performed in 15 static cycles using the standard method, with 5 min each at 160° C. using a rinse volume of 100% and a purge time of 90 s with the solvent system 1.5 wt % of H₂SO₄ in aqueous ethanol solution (30:70 v/v). In the HW extraction, a fixed volume program was used and the L/W ratio could be determined to be 8. At the beginning of the organosolv extraction, after the hemicellulose fraction had been extracted, the L/W ratio was estimated to by 10 and at the end of the cycle, it was estimated to be 12. The total amount of solvent used in the cyclic organosolv method was 340 mL.

As mentioned earlier, the ASE instrument operates at a fixed pressure of 1500-1600 psi in the standard method. When the fixed volume program was used, the solvent volume was selected to reach a pressure of 1600 psi in the cell so as to achieve sufficient pressure and subcritical conditions. The fixed volume program was used in all experiments except for the last static cycle method where the standard method was used. More liquid was used in the extraction series since every fraction was collected and analysed manually. The ASE instrument has an integrated oven and temperature control system, from which the temperature is monitored. After the system has pumped the solvent into the cell, the cell is heated for 8 min before the extraction procedure starts.

The HW extract was lyophilized directly. The lignin sample obtained from the organosolv extraction was evaporated under reduced pressure. During this evaporation the pH was monitored, and water was added to avoid a change in the acidity of the extract. The precipitated lignin in this acidic water solution was vacuum filtrated and rinsed with water until a clear filtrate was obtained. The efficiency of the wash was substantiated by HSQC analysis, during which no signals from carbohydrates were detected. The rinsed lignin samples were collected and lyophilized. A schematic illustration of the method is shown in FIG. 14. Fractionation was performed by adding lyophilized lignin/ethanol (1:40 w/w) to a closed vial with magnet stirring for 2 h. The solution was filtered under vacuum filtration and the residue rinsed with a small amount of ethanol.

The MWL was prepared according to the Björkman procedure (A. Björkman, Svensk Papperstidning 1956, 59, 477-485.) with some slight modification. Shortly, in a Teflon-lid bottle, dioxane-water mixture (200 mL, 96:4 v/v) was added to extractive-free ball-milled spruce wood (10 g) and the mixture was stirred at room temperature for 48 h. The dark-brown suspension was then centrifuged (Beckman Coulter Avanti J-E, equipped with JA 25.5 rotors at 20000 rpm) for 20 min and the obtained supernatant was collected in a round bottom flask before being concentrated under reduced pressure to a volume of approximately 100 mL. After the addition of deionized water (150 mL) and the precipitation of the extracted lignin, the residual dioxane was completely removed by rotary evaporation. Finally, the thus-obtained sample was freeze dried to obtain MWL as a light brown powder. The resulting samples were analyzed by SEC, NMR spectroscopy, XRD, and HPLC.

### Chemical Composition of the Biopolymer Fractions

The carbohydrate composition was investigated according to the acid hydrolysis protocol (SCAN, SCAN-CM 71:09 Scandinavian Pulp, Paper and Board testing Committee, Stockholm, Sweden, 2009). The Klason lignin and acid-soluble lignin (ASL) contents were determined as previously reported (TAPPI UM 250, TAPPI Useful Methods, 1991, Tappi, Atlanta, GA, USA, 1991 and TAPPI T 222 om-02, TAPPI Test Methods, Tappi Press, Atlanta, GA, USA, 2002.) Hydrolysis was performed on the Wiley-milled wood fraction, the hydrothermal extract fraction as well as the fiber residues after hot water and organosolv extraction. In short, to 200 mg of the respective fractions, that is, wood, extracted fibers and the hydrothermal extract fractions, 72% sulfuric acid (3 mL) was added. The mixture was placed under vacuum for 80 min with occasional stirring. The mixture was thereafter diluted with Milli-Q water (84 mL) and placed into an autoclave for 60 min at 125° C., following by vacuum filtration and 5×2 mL rinsing of the collected Klason lignin on the glass fiber filter.

Carbohydrate quantification was performed by using high-performance anion-exchange chromatography with pulsed amperometric detection (HPAEC/PAD). The method setup has been previously reported (S. Azhar, G. Henriksson, H. Theliander, M. E. Lindström, Carbohydr. Polym. 2015, 117, 19-24.). Using 260 mm sodium hydroxide and 170 mm sodium acetate, the system was equilibrated for 7 min followed by equilibration with Milli-Q water for 6 min. Milli-Q water was used as an eluent at a flow rate of 1 mLmin⁻¹. At the column eluate, 300 mm sodium hydroxide was added before the PAD cell, at a flow rate of 0.5 mLmin⁻¹. Quantification was carried out by using anhydro correction factors of 0.90 and 0.88 for hexoses and pentoses, respectively, according to a previously reported method (N. Giummarella, L. Zhang, G. Henriksson, M. Lawoko, RSC Adv. 2016, 6, 42120-42131.). The Klason lignin was gravimetrically quantified after being ovendried overnight. The ASL was quantified by UV spectroscopy at 205 nm using an extinction coefficient of 128 Lg⁻¹cm⁻¹ for softwood and a correction factor of 0.2 for carbohydrate degradation products (KCL (Finnish Pulp and Paper Research Institute) Reports; KCL: Espoo, Finland 1982, Vol. 115b, p. 3.).

### X-Ray Diffraction

The X-ray diffraction was performed using an ARL X′ TRA Powder Diffractometer (Thermo Fisher Scientific Inc., USA) using Cuka radiation generated at 45 kV and 44 mA. The measurements were performed using scans from 20=5° to 50° in steps of 0.058 at a scan rate of 3 s per step.

### Size-Exclusion Chromatography

Lyophilized sample (˜9 mg) was dissolved in a 0.5 wt % LiBr solution in DMSO (2 mL). The dissolved sample was syringe filtered using a 0.45 mm PTFE filter. SEC was run using 0.5 wt % LiBr solution in DMSO as eluent, with an injection volume of 100 μL, a flowrate of 0.5 mLmin⁻¹, and a column oven temperature of 60° C. For integration, RI detection at 40° C. was used. Standard calibration was performed by using Pullulan standards in the molecular range of 342-708×103 Da.

### NMR Spectroscopy

For the HSQC-edited analysis, lyophilized sample (80 mg) was dissolved in [D₆] DMSO (600 μL). The spectra were acquired on a Bruker 400 DMX spectrometer with the “hsqcedetgp” pulse sequence using the following parameters: an acquisition time of 0.1065 s, a relaxation delay of 2.5 s, 80 scans using 1024×256 increments. Optimal pulse lengths corresponding to a 90° pulse were found for each experiment by finding and halving the pulse length corresponding to a 180° pulse where the proton FID signal was minimal. Data processing was carried out in MestReNova with 1024×1024 data points using a 90° shifted square sine-bell apodization window. The data was Fourier transformed followed by phase correction and baseline correction in both dimensions by a Bernstein polynomial fit of order 3. Semi-quantification of lignin interunit linkages was carried out by using the C2-H signal region on the aromatic ring as an internal standard (M. Sette, R. Wechselberger, C. Crestini, Chem. Eur. J. 2011, 17, 9529-9535.). All NMR spectra were integrated by using the same shifts for comparable results.

HMBC analyses were performed on the same samples as for the edited-HSQC analyses using the same instrument and the same acquisition parameters, except for the use of the ‘hmbcgpndqf” pulse program.

Quantitative ³¹P NMR sample preparation was performed based on a reported method (a) D. Argyropoulos, Res. Chem. Intermed. 1995, 21, 373; b) A. Granata, D. S. Argyropoulos, J. Agric. Food Chem. 1995, 43, 1538-1544.). Lyophilized sample (30 mg) was dissolved in N, N-dimethylformamide (100 μL) and pyridine (100 μL). To this solution, internal standard (IS) solution (50 μL; 60 mgmL⁻¹ of eHNDI in pyridine with 5 mgmL⁻¹ Cr (AcAc3) relaxing agent) was added. After stirring, C1-TMDP phosphorylating agent (100 μL) was added following by dropwise addition of CDCl₃ (450 μL) to the sample solution. The ³¹P NMR spectra were acquired with 512 scans and a relaxation delay time of 6 s on a Bruker NMR spectrometer Avance III HD 400 MHz. Data processing was carried out in MestReNova. The data were Fourier transformed followed by phase correction and baseline correction in both dimensions by a Bernstein polynomial fit of order 3.

1. A method for extraction of hemicellulose, lignin and carbohydrates from a lignocellulosic biomass comprising hemicellulose, lignin, carbohydrates and fiber, wherein the method comprises the following steps:
1) extracting hemicellulose from lignocellulosic biomass, leaving a first fiber residue, wherein step 1) comprises:
1a) providing lignocellulosic biomass and a first solvent in a first container, wherein the first solvent is subcritical water, wherein the volume of the first solvent is such that a pressure of from atmospheric pressure up to 2000 psi is reached in said first container,
1b) heating said biomass and first solvent to a temperature of 110-170° C., while maintaining a pressure in said first container of from atmospheric pressure up to 2000 psi,
1c) letting said biomass and said first solvent be in contact, while maintaining a temperature of 110-170° C. and, while maintaining a pressure in said first container of from atmospheric pressure up to 2000 psi, for a period of time, so that at least a part of the hemicelluloses of the lignocellulosic biomass are extracted from said biomass, leaving a first fiber residue,
1d) recovering at least a part of said first solvent with at least part of the extracted hemicellulose from said first container,
2) extracting lignin and carbohydrates from said first 30 fiber residue, to leave a second fiber residue, wherein step 2) comprises:
2a) providing said first fiber residue and a second solvent in a second container, said second solvent comprising ethanol and water, wherein the volume of second solvent is such that a pressure of from atmospheric pressure up to 2000 psi is reached in the second container,
2b) heating said first fiber residue and said second solvent to a temperature of 110-170° C., while maintaining the pressure in said second container at from atmospheric pressure up to 2000 psi,
2c) letting said first fiber residue and said second solvent be in contact, while maintaining a temperature of 110-170° C. and, and while maintaining a pressure in said first container of from atmospheric pressure up to 2000 psi, for a period of time such that at least a part of the lignin and at least part of the carbohydrates are extracted from said first fiber residue, leaving a second fiber residue,
2d) recovering at least a part of said second solvent with at least part of the extracted lignin and carbohydrates from said second container,
2e) optionally separating the extracted carbohydrates and the extracted lignin in a washing step.

2. The method for extraction according to claim 1, wherein the step 1d) comprises at least one of the following steps:
recovering residual first solvent by applying pressurized gas, wherein the gas optionally is an inert gas; and
recovering residual first solvent by rinsing with water.

3. The method for extraction according to claim 1, wherein the step 2d) comprises at least one of the following steps:
recovering residual second solvent by applying pressurized gas, wherein the gas optionally is an inert gas; and
recovering residual second solvent by rinsing with ethanol.

4. The method for extraction according to claim 1, wherein the ratio of ethanol to water in the second solvent is between 60:40 (v/v) and 80:20 (v/v).

5. The method for extraction according to claim 1, wherein said second solvent comprises a mineral acid.

6. The method for extraction according to claim 1, wherein step 2c)-2d) comprises a plurality of static cycles, wherein each static cycle comprises the steps of:
6a) maintaining said first fiber residue and said second solvent in said second container at a temperature of 110-170° C. for a time period of from 1 to 20 minutes,
6b) introducing a volume X of new second solvent to said second container and simultaneously discharging the same volume X of the second solvent with at least at part of the extracted lignin from the second container.

7. The method for extraction according to claim 6, wherein the volume X of new second solvent introduced and discharged during at least one static cycle is 10-30% (v/v) of the volume Z of the second solvent provided in step 2a).

8. The method for extraction according to claim 1, wherein the first and/or second solvent has a temperature of up to 170° C. when provided in step 1a) and/or 2a) and/or introduced in step 6b).

9. The method for extraction according to claim 1, wherein the first and/or second solvent has a temperature of 110-170° C. when provided in step 1a) and/or 2a) and/or introduced in step 6b).

10. Lignin obtained by the method according to claim 1.
